(19) United States
(12) Patent Application Publication
(10) Pub. No.: US 2025/0236222 A1
(43) Pub. Date: Jul. 24, 2025

(54) CHILD SEAT BASE FOR RECEIVING A SEAT ELEMENT

(71) Applicant: CYBEX GmbH, Bayreuth (DE)

(72) Inventors: Cameron KORNELSEN, Bayreuth (DE); Nilesh KATKAR, Bayreuth (DE); Lukas STUTTERECKER, Bayreuth (DE)

(21) Appl. No.: 18/714,007

(22) PCT Filed: Nov. 30, 2022
(86) PCT No.: PCT/EP2022/083775

§ 371 Date: May 28, 2024

(30) Foreign Application Priority Data
Nov. 30, 2021 (DE) 20 2021 106 522.2

(51) Int. Cl. B60N 2/28

(52) U.S. Cl. CPC B60N 2/2821

(57) ABSTRACT

The invention relates to a child seat base for receiving a seat element of a child seat system and for mounting in a motor vehicle, comprising several fastening devices, in particular locking elements, for fastening the seat element to the child seat base, which can be brought from a locking position into a release position, wherein at least a first of the fastening devices is configured differently from at least a second of the fastening devices with respect to a rotatability or a lockability or a shape or a choice of material.

The invention relates to a child seat base for receiving a seat element of a child seat system for mounting in a motor vehicle as well as a corresponding child seat system.

Child seat systems are normally used in motor vehicles to protect children from serious injury in the event of an accident. In general, a child seat system comprises the actual child seat (seat element) for accommodating a child and also a support base (child seat base), which can be installed on a vehicle seat and forms a supporting base for the child seat. In order to be able to use the support base with further child seats and/or to enable an easier transport of the child seat, support bases often have mechanisms for detachably fastening child seats. However, a suitable fastening mechanism is required to securely and easily fasten the child seat to the support base.

Exemplary systems are known from EP 2 210 768 A2 and EP 1 369 295 A1. In EP 2 210 768 A2, four fastening devices are proposed, which are designed as hooks. In EP 1 369 295 A1, fastening devices are proposed that are designed as pins.

In general, there is a need for a child seat system that enables convenient and safe attachment and removal of the child seat at the support base. The solutions of the prior art are still considered to be in need of improvement in this respect. Furthermore, the design complexity of these solutions in particular is considered to be comparatively high.

It is the object of the invention to propose a child seat base for receiving a seat element of a child seat system for mounting on a motor vehicle, as well as a corresponding child seat system, wherein a high level of safety is to be achieved in connection with the attachment of the seat element in a comparatively simple and cost-effective manner.

This object is solved in particular by the features of claim 1.

In particular, the object is solved by a child seat base for receiving a seat element (child seat) of a child seat system, wherein the child seat base or the child seat system is configured for mounting in a motor vehicle, wherein the child seat base comprises several fastening devices (fastening elements, in particular locking elements) for fastening the seat element on the child seat base, which can be brought from a locking position into a release position (and vice versa), wherein at least a first of the fastening devices is configured differently from at least a second of the fastening devices. The deviating configuration preferably relates to a rotatability (of the respective fastening device, wherein preferably the at least one first fastening device is rotatable and the at least one second fastening device is not, or vice versa) and/or a lockability (of the respective fastening device, preferably of the locking position of the respective fastening device, in particular in such a way that the at least one first fastening device can be locked or is locked in particular in its locking position and the at least one second of the fastening devices cannot, or vice versa) and/or a shape (of the respective fastening device, in particular in such a way that only the at least one first fastening device comprises or forms a structure that reaches around, preferably a hook, but not the at least one second fastening device) and/or a choice of material (in particular such that the at least one first fastening device is made at least in sections from metal, in particular is made predominantly from metal, and the at least one second fastening device is made at least partially, in particular predominantly, from plastic) and/or an influence on an indicator device (in particular for indicating a status of the respective fastening devices, for example such that the indicator device indicates, in particular directly, a locking position of the at least one first fastening device but not of the at least one second fastening device, at least not directly).

One idea of the invention is to deliberately provide fastening devices configured in different ways. By this it can be achieved that, for example, a (possibly unrecognised) weak point, which could be present in a plurality of at least essentially identical fastening devices, has negative effects.

Furthermore, this makes it possible to design individual fastening points in a complex (or possibly less complex) way according to their (in particular safety-related) relevance.

A fastening device can be understood to mean, for example, a fastening element (possibly in one piece or designed as a coherent component). The fastening element can be monolithic and/or moulded onto another component, e.g. a connecting device.

A locking position is to be understood as a position of the respective fastening device in which a seat element is held by the respective fastening device when it is (properly) positioned on the child seat base. Correspondingly, a release position is to be understood as a position in which the seat element can be released from the child seat base (in relation to the respective fastening device). If a seat element is (properly) arranged on the child seat base, a complete release of the seat element can preferably only occur when all (or all but one of the) fastening devices are in their release position.

The child seat system comprises a child seat (seat element) for accommodating children and a support base (child seat base) for providing a support for the child seat, wherein the child seat can be detachably installed on the support base.

The child seat base can have a shell body to which the seat element can be fastened. The shell body can have an upper shell part and a lower shell part and/or have an at least partially hollow interior. The shell body of the child seat base can have an upper side that is suitable for receiving the seat element. For example, an underside of the seat element may have a rod in the front and/or, preferably, rear area (if applicable, either) extending from a left to a right side of the seat element, while the upper side of the shell body may have one or more recess(es) to at least partially receive the (respective) bar when the seat element is placed on the child seat base.

Alternatively or additionally, the underside of the seat element may, preferably, have in the front and/or rear area at least one recess extending at least approximately in the transverse direction or two recesses spaced apart from each other in the transverse direction. Engagement elements may be provided on the upper side of the child seat base, which may at least partially engage in these recesses and/or co-operate with corresponding engagement elements of the seat element.

The child seat base can have a fastening mechanism which manages to fasten the seat element to the child seat base and to release it from the child seat base for its removal. The fastening mechanism can have several fastening devices (fastening elements).

Two fastening devices should differ in their rotatability in particular if one fastening device is rotatable, in particular about a predetermined axis, and the other is not (for example, is only translationally displaceable and/or only deformable). However, the case may also be encompassed that one of the fastening devices is rotatable over a larger angle (e.g. an angle at least 1.5 times or at least 2.5 times as large) compared to the other fastening device. A (mere) difference with regard to a direction of rotation should in particular not be regarded as a difference with regard to rotatability.

Two fastening devices should differ with regard to their lockability in particular if one fastening device is lockable and the other is not, or if the type of locking (for example, in one case by means of a positive fit and in another case by means of a frictional connection) differs. In particular, a fastening device should be considered to be locked or correspondingly lockable if it is immovable in a locked state (or at least only so little movable that no change between locking position and release position can take place). Lockability in this sense should not be deemed to exist in particular if the corresponding fastening device is only inaccessible from the outside and therefore could not be moved by hand, for example.

If a certain material is “predominantly” present, this should in particular mean “at least 50% by weight” (based on the total weight of the corresponding device or the corresponding element).

In general, therefore, the fastening devices can be formed differently.

Preferably, at least a first one of the fastening devices is lockable or locked in its locking position by means of at least one locking device, wherein at least one second one of the fastening devices is movable in its locking position. Here too, “movability” does not necessarily mean that the corresponding fastening device can be moved from the outside (by hand), but (only) that it is not blocked against a (possibly only imaginary) movement of its own. In particular (as above), only movements should be considered that can generally take place during proper use when transferring from the locking position to the release position or vice versa.

At least one (in particular the first)—but preferably not all—fastening device(s) may comprise a hook. Alternatively or additionally, at least one (in particular second) fastening device may comprise a pin (but in particular no hook). In embodiments, several or all first fastening devices may comprise a hook (or be formed as a hook) and several or all second fastening devices may comprise a pin (or be formed as a pin). Specifically by the combination of hooks (in particular in a rear area) and pins (in particular in a front area) a variable and secure fastening system is achieved in an advantageous way.

The at least one first fastening device (possibly several or all first fastening devices) is/are preferably (only) rotatable (i.e. not translationally displaceable). Alternatively or additionally, the at least one second fastening device (or several or all second fastening devices) is (only) translationally displaceable (i.e. in particular not rotatable). It Is also conceivable that a respective fastening device is both rotatable as well as translationally displaceable (simultaneously and/or sequentially). Safety can also be improved by this variation in relation to the basic movement.

The child seat base can have a support foot and/or an Isofix anchoring device.

It is particularly preferred if the at least one first fastening device (in particular several or all of the fastening devices) is (are) arranged further back than the at least one second fastening device (in particular several or all of the second fastening devices). An arrangement “further back” is to be understood as an arrangement that is closer to a rear end of the child seat base. A rear end of the child seat base is preferably defined by that end which faces a backrest of the motor vehicle when the child seat base is properly arranged and/or an end which is closer to an Isofix anchorage and/or is further away from a support foot. In embodiments, the respective first fastening device may be arranged at least 5 cm or at least 15 cm or at least 20 cm further back than the at least one second (or several or all second) fastening device(s). Specifically, the respective first fastening device may be arranged in a rear third and/or the respective second fastening device may be arranged in a front third of the child seat base.

In particular, one consideration of the present disclosure is also to deliberately design the (respective) rear fastening device to be comparatively complex or secure. It was considered that the (respective) rear fastening device is of particular importance in the event of a frontal collision or that a failure of the rear fastening device with a higher probability has more serious consequences than a failure of a front fastening device. Because, if only the front fastening device is still holding (in the event of a frontal crash), the seat element will have the tendency to rotate or tilt forwards due to its inertia, which in itself is highly problematic for the child and can also result in particularly large forces acting on the (initially still holding) second fastening device, so that this also fails. Especially if the child seat base is anchored or can be anchored to the motor vehicle seat via an Isofix anchorage (located at the rear) and/or another fastening structure located at the rear and possibly at the bottom, a comparatively complex design of the (respective) first or rear fastening device is particularly advantageous.

In embodiments, several or all first fastening devices can be arranged at the “same level” (in relation to a direction from the rear to the front). Alternatively or additionally, the same applies to several or all second fastening devices. Specifically, several or all first fastening devices and/or several or all second fastening devices can be aligned with each other in a line along a left-right direction.

Preferably, at least one Indicator device is provided which is configured to indicate whether the at least one first fastening device is in its locking position or not. Alternatively or additionally, the indicating device (or a further indicating device) may be provided to indicate to what extent the at least one second fastening device is in its locking position or not. Preferably, however, it is only indicated directly whether the at least one first fastening device is in its locking position or not. In particular, a direct indication means that the indicating device is forcedly coupled to the corresponding fastening device in such a way that it is not possible to bring the fastening device to a state that deviates from an indicated state. Accordingly, an only indirect indication means that the corresponding fastening device can be brought into a state that deviates from the indicated state (possibly even if such a deviation of the indicated state from the actual state does not occur during proper use).

Overall, by this, with respect to the indicating device, the complexity of the control or triggering of the same is reduced, which increases the probability of a correct indication in relation to the respective first fastening device.

The fastening devices (fastening elements) can be designed differently. On the one hand, the fastening devices (fastening elements) can be designed in such a way that they at least partially reach around the bar of the child seat, in particular as hooks. On the other hand, the fastening devices (fastening elements) can be designed as engagement elements, in particular as pins, which can at least partially engage in recesses of the child seat, for example.

In particular, front fastening elements can be designed as engagement elements, in particular as pins, and rear fastening elements, which in use are closer to the backrest of the vehicle seat, as hooks, or vice versa.

The fastening devices (fastening elements), in particular those in the form of hooks, can be arranged adjacent to recesses and/or engage rods. The recesses can be located, for example, on a support base arranged in the shell body. The fastening elements, in particular the hooks, can be mounted on the support base, in particular in recesses of the support base, in particular spring-mounted, in particular by springs. The fastening elements, in particular the hooks, can be pretensioned by springs, in particular into the open position.

According to embodiment, several or all of the first fastening devices can move independently of each other. Optionally, several or all of the second fastening devices can also move independently of each other. Preferably, however, several or all of the second fastening devices are connected to each other (possibly in one piece).

Several first fastening devices can interact with each other, preferably in such a way that they only remain in locking position when they have all been brought into the locking position.

Alternatively or additionally, several or all of the second fastening devices can interact with and/or be coupled to each other, in particular in such a way that a movement of the several second fastening devices can be enabled by a common drive (push and/or pull) device (e.g. belt).

Alternatively or additionally, several fastening devices may be present, wherein the several fastening devices comprise at least one first and at least one second fastening device and interact with each other, preferably such that a transfer of the at least one second fastening device into its locking position is (only) made possible by a transfer of the at least one first fastening device into its locking position and/or a transfer of the at least one second fastening device into its locking position is impossible as long as at least one (or several or all) first fastening device(s) are in their release position.

In a specific embodiment, several first fastening devices interact with each other via a control device (of the child seat base), wherein the control device can preferably be brought into at least one first and at least one second position, in particular by rotation (possibly alternatively or additionally by translation). Further preferably, the control device (control element) only locks the (respective) locking position of the first fastening device(s) in the first position and/or can (only) be transferred to the first position when the several first fastening devices are in their locking position. Alternatively or additionally, the control device (and/or an additional structure) may prevent the several first fastening devices from moving further away from the locking position when they are in the release position.

In embodiments, several fastening devices may be provided, wherein the several fastening devices comprise at least one first and at least one second fastening device, and wherein the fastening devices are (mechanically) connected to each other, at least in sections, via a connecting device (connecting element).

The connecting device can be configured in such a way that a transfer of the at least one second fastening device into its locking position is (only) made possible by a transfer of the at least one first fastening device into its locking position.

Alternatively or additionally, the connecting device can be (directly or indirectly) connected to the control device.

Alternatively or additionally, the connecting device can be designed to be flexible (in particular at least in sections as a flexible band and/or at least in sections as a flexible cable). The connecting device can be suitable for transmitting not only tensile forces but also shear forces. Furthermore, the connecting device can be made of plastic, for example by injection moulding.

Alternatively or additionally, the connecting device can extend over at least 25%, preferably at least 50%, of a length of the child seat base.

Alternatively or additionally, the connecting device can be (directly) connected, preferably firmly (or in particular non-detachably), to at least one second fastening device, in particular forming an integral unit with at least one second fastening device.

Preferably, (at least) one actuating device is provided, wherein at least one or several or all fastening device(s) can be transferred into the release position by an actuation of the actuating device.

In embodiments, at least one first spring device is provided, which preferably urges at least one fastening device, further preferably at least one first fastening device, in the direction of the release position. Alternatively or additionally, at least one second spring device is provided, which preferably urges at least one fastening device, further preferably at least one second fastening device, in the direction of the locking position.

Preferably, an (the) indicating device is provided for indicating a status of at least one fastening device, wherein the indicating device is preferably coupled (in particular directly) to a position of the control device.

Preferably, an/the indicating device is designed such that the adoption of the locking position of the at least one first fastening device is only indicated when (after) a/the transfer of the at least one second fastening device into its locking position has been enabled and/or has taken place.

Alternatively or additionally, an/the actuating device can be designed such that the at least one first fastening device is only transferred to its release position when (after) an indication of the locking position of the at least one first fastening device by the indicating device no longer takes place.

According to a further (independent or furthering) aspect, the above-mentioned object is in particular further solved by a child seat base for receiving a seat element of a child seat system and for mounting in a motor vehicle, preferably as described above and/or below, wherein it need not necessarily be the case (but may be the case) that at least one first fastening device is configured differently from at least one second fastening device. According to the further aspect, the child seat base comprises several fastening devices, in particular locking elements, for fastening the seat element to the child seat base, which can be brought from a locking position into a release position, wherein an (the) actuating device is provided, wherein at least one or several or all of the fastening device(s) can be transferred into the release position by actuating the actuating device, wherein the fastening devices are connected to each other and/or to the actuating device, at least in sections, via a (the) connecting device, wherein the connecting device is flexible and/or in the form of a band or comprises such a band and/or is preferably made of plastic, in particular as an injection-moulded part.

The above-mentioned object is further solved in particular by a child seat system for mounting in a motor vehicle, comprising a seat element as well as the above child seat base.

In particular, the above-mentioned object is furthermore solved by a method for attaching the seat element to the child seat base, wherein the above and/or following functional features of the seat element and/or the child seat base can be carried out as specific method steps.

The above-mentioned object is in particular further solved by a method for arranging, in particular fastening, the child seat system in a motor vehicle, in particular on a preferably forwardly orientated motor vehicle seat, further preferably via a fastening device at a rear and possibly lower end of the child seat system, still further preferably via an Isofix anchorage, wherein functional features of the seat element and/or the child seat base described above and/or below can be carried out as specific method steps.

The above-mentioned object is in particular further solved by a vehicle, in particular a motor vehicle, with a child seat system as described above and/or below arranged, in particular fastened, in and/or on the vehicle (preferably on a particularly forwardly oriented seat of the vehicle).

Still further optional features and aspects of the child seat base or the child seat system are described below.

The first fastening devices (fastening elements) can interact with each other. In particular, the (at least two) fastening devices (fastening elements), especially the hooks, can interact in such a way that they only lock when both hooks have been brought into the locking position. By this an unintentional and incorrect locking can be prevented.

The second fastening devices (engagement elements), in particular pins, can interact with the first fastening devices (hooks). The locking of the first fastening devices (engagement elements) can be triggered in such a way that locking is only triggered as soon as both hooks have been brought Into the locking position.

An interaction of the first fastening devices (hooks) can be achieved in particular via a (the above) control device (control element). In particular, the control element can be brought into at least two positions. In particular, the control element can be designed in such a way that it is rotatably mounted, in particular via an axis of rotation, preferably on a support base, and can be brought into at least two positions via this rotational mobility. In particular, the control element can be designed in an angular or angled bracket shape, the open ends of which preferably engage in openings in the support base and, in particular, are attached rotatably movable to the support base below the hooks. In a first position of the control element, in particular the locking position, the fastening elements are preferably in the locking position. In a second position of the control element, in particular the open position, the fastening elements are preferably in open position (or at least not in a permanently locked position). The control element can be pretensioned by at least one spring, in particular a moving spring, in one of the two positions, in particular towards the open position.

Engagement devices (engagement elements) can be attached to the control element (at free ends), for example comprising at least one engagement arm. At least one or at least or exactly two latching point(s) is/are preferably provided on the hooks.

The respective engagement device is preferably designed to be brought into engagement with the latching point(s) of the respective (first) fastening device (hook).

When the engagement device (engagement arm) engages in the first latching point, in particular locking point, the respective (first) fastening device (hook) is preferably in the locking position. When the engagement device (engagement arm) engages in the second latching point, in particular the release position point, the respective (first) fastening device (hook) is preferably in the open position.

In the open position, the respective fastening device (fastening element), in particular hook, can have play, for example due to the shape of the latching points, and can be brought into the locking position by external action against a spring force, but may possibly be movable back into the open position due to the spring force. Preferably, only when one or all further fastening device(s) (e.g, a second hook) is also rotated into the locking position can the control element move into its second position, in particular the locking position, due to spring force, in particular the spring force of the moving spring, and thus lock the further fastening device(s) (e.g. the second hook) in the locking position by the engagement of the engagement device (of the engagement arm) in the corresponding latching point(s) of the further fastening device(s). By a rotation of the several first fastening devices (both hooks) into the locking position, the engagement device (the engagement arm) can engage in the corresponding (first) latching point, in particular locking point, whereby the fastening mechanism can ultimately be locked. Otherwise, the movement of the engagement device (of the engagement arm) into the (first) latching point is prevented, the mechanism is then in the unlocked position.

To the control device (control element) a (the above) connecting device (connecting element) can be attached, in particular detachably, which preferably extends towards the second fastening devices (engagement elements, in particular pins) in order to couple these further preferably with the entire locking mechanism.

The connecting element may be connected to the control element in such a way that it is driven by the movement of the control element from the first to the second position (or vice versa), and/or that the movement of the control element from the first to the second position (or vice versa) is driven by the movement of the connecting element. The connecting element can be formed to be flexible. The connecting element can be attached to a main body of the child seat base, in particular to the shell body, in such a way that its movement is guided on the main body (shell body), in particular by a guide on the main body (shell body).

In particular, it can be connected to the main body (shell body) in such a way that a rotational movement of the control element is converted into a translational movement and/or that a translational movement of the connecting element is converted into a rotational movement of the control element.

In particular, the connecting element can be formed in one piece with the second fastening devices (engagement elements, in particular the pins).

In particular, the connecting element can be designed in such a way that it engages with the control element in one piece, but tapers off in two parts to the respective engagement elements, in particular pins.

In particular, the connecting element can be designed or shaped and/or connected to the main body of the child seat base (shell body) in such a way that it is moved in longitudinal direction, but this longitudinal movement tapers off in a lateral direction (in the horizontal plane), in particular laterally in two opposite directions.

By a rotational movement of the control element, the connecting element can preferably be driven translationally in the longitudinal direction and (by its shape and/or by a deflection mechanism such as at least one bevelled groove) drive the second fastening devices (engagement elements, in particular the pins) in the lateral direction, in particular into released position.

The engagement elements driven in the opposite direction, in particular the pins, can be spring-mounted on the main body of the base (shell body) so that they are pretensioned, in particular towards the closed position. The springs, in particular moving springs, can in particular be attached to the connecting element and the control element in a supporting manner, so that the movement of the control element from the open position to the closed position is at least supported, in particular achieved, by these springs via the connecting element.

In addition, at least one unlocking element can be provided as an actuating device that can return the fastening mechanism or the fastening elements from the locking position to the open position. In particular, the unlocking element can be arranged in such a way that it engages with the control element and drives it out of the locking position into the open position, in particular against the spring force of the moving spring, as soon as the unlocking element is actuated. The unlocking element can, in particular, be designed as a lever. In particular, the unlocking element can be rotationally movably attached to the main body (shell body), especially the support base. In particular, the unlocking element can be attached to the support base in a spring-loaded manner.

The locking mechanism can also have at least one (in particular the above) indicating device (status indicator), with which it is indicated whether the fastening elements are in the locking position or in the open position. The status indicator can be connected to the main body (shell body) in a movable manner, in particular in a swivelling manner, in particular in a spring-loaded swivelling manner. The status indicator can be dependent on the movement of the control element from the open position to the locking position (or vice versa), in particular it can be triggered by this. The status indicator may be in direct contact with the control element, in particular be connected to it and/or in particular resting on it.

If the indicating device indicates (indexes) the status of only one or in any case not all of the fastening device(s), it may be provided that assuming the locking position of the indexed fastening device(s) only happens after the transfer of the non-indexed fastening device(s) into its locking position has been enabled and/or has taken place. Alternatively or additionally, it may be provided that the transfer of the indexed fastening device(s) into their release position only takes place after an indication of the locking position of the indexed fastening device(s) by the indicating device no longer occurs.

Further embodiments are shown in the dependent claims.

The invention is described below with reference to an embodiment example, which is explained in more detail with reference to the figures. Hereby show:

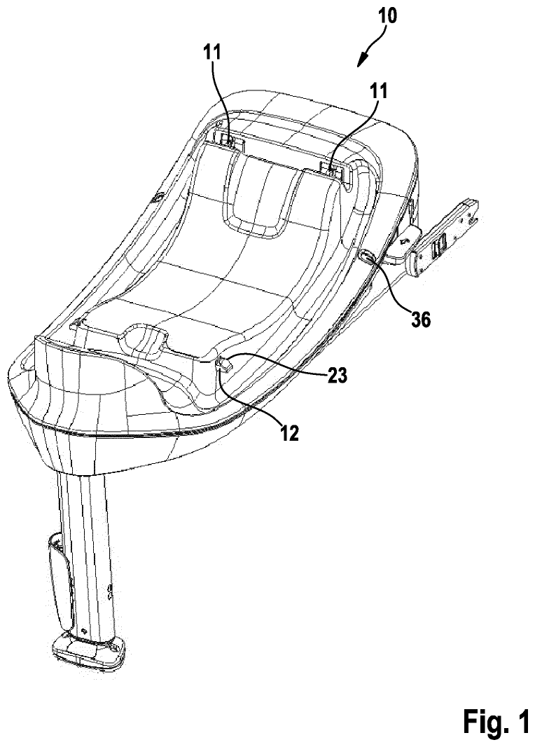

FIG. 1 an oblique view of a child seat base according to the invention in a schematic illustration;

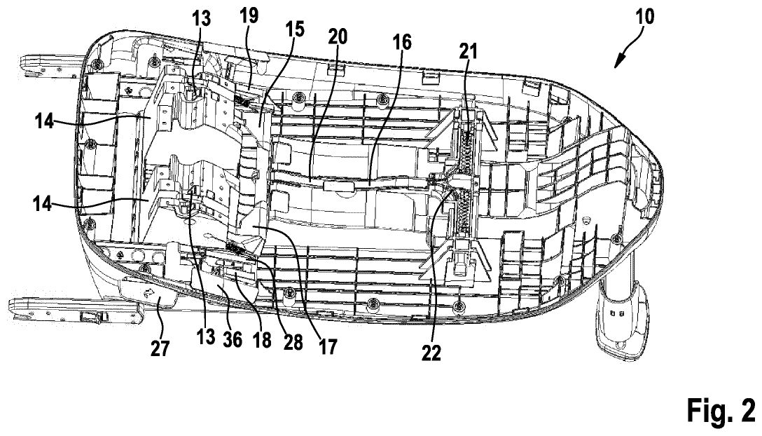

FIG. 2 a schematic interior view of the child seat base according to FIG. 1 in a first illustration;

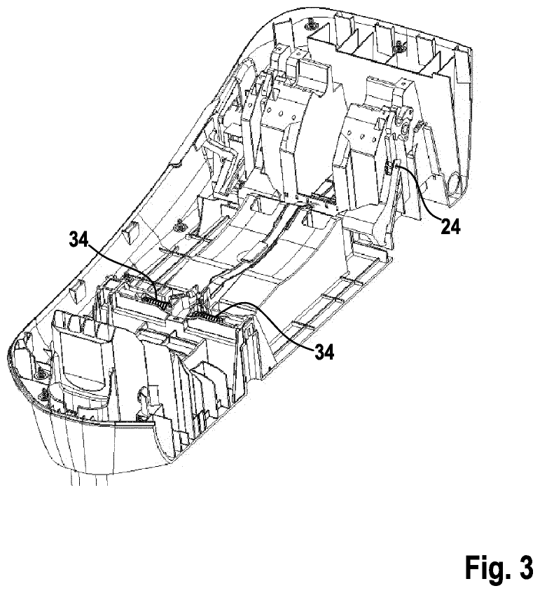

FIG. 3 a schematic interior view of the child seat base according to FIG. 1 in a first state;

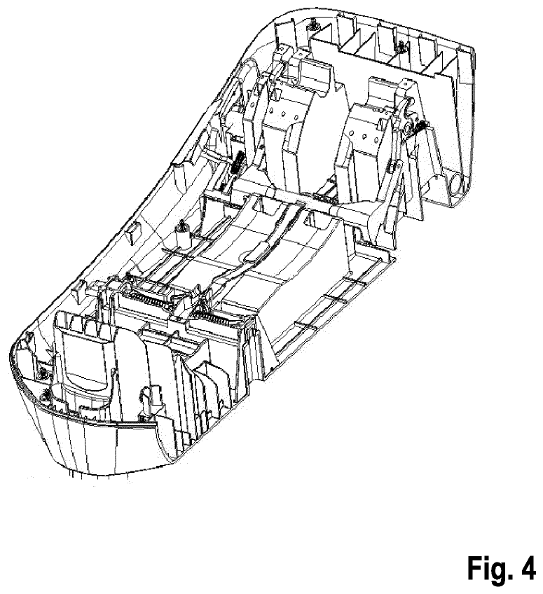

FIG. 4 an illustration analogous to FIG. 3 in a second state;

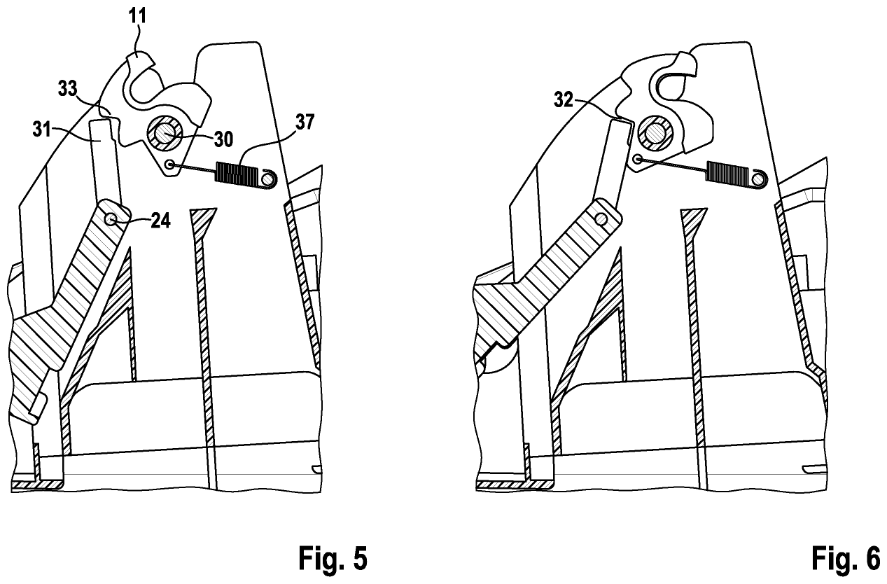

FIG. 5 a sectional illustration of a section of the child seat base according to FIG. 1;

FIG. 6 the section according to FIG. 5 in an different illustration;

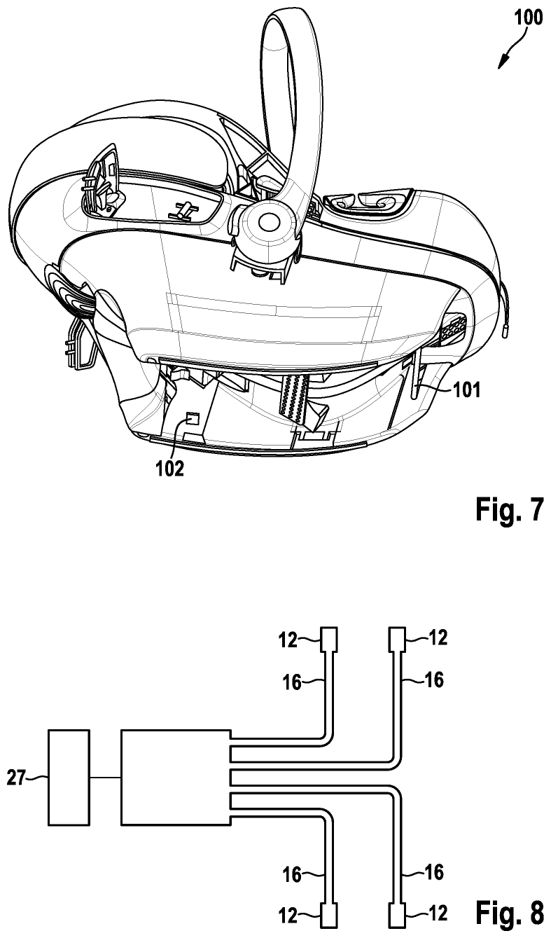

FIG. 7 a seat element for the child seat base according to FIG. 1 in a schematic oblique illustration; and

FIG. 8 a highly schematic illustration of some components of an alternative design.

In the following description of the figures, the same reference numbers are used for identical and identically acting parts.

FIG. 1 shows a child seat base 10, which has several (optionally four in the present embodiment example) fastening devices, namely several (for example two each) first fastening devices 11 (see also FIG. 5) as well as second fastening devices 12 (of which only one can be seen in FIG. 1). The first fastening devices 11 comprise hooks or are formed from such hooks. The second fastening devices 12 comprise pins (or are formed by such pins). The first fastening devices 11 can accordingly be brought into engagement with a rod 101 of a seat element 100 (see FIG. 7). The pins 12 can be brought into engagement with corresponding recesses 102 (see also FIG. 7) of the seat element 100.

The rod 101 or the recess 102 can also be formed by other fastening devices (complementary to the fastening devices of the child seat base), For example, the rod 101 can be replaced by several rods and/or bars. The recesses 102 can, for example, be formed by a step, a projection and/or an undercut.

Particularly preferably, the first fastening devices 11 are designed such that they reach around a complementary fastening structure (e.g. rod) of the seat element, at least in sections. The second fastening devices 12 are preferably designed in such a way that they do not reach around a complementary counter-structure of the seat element, for example they can only be inserted into a corresponding recess.

Specifically, the child seat base 10 can have one or more (in embodiments according to FIG. 1 two, see also FIG. 2) (in particular elongated) recesses 13, which can be formed, for example, by one or more corresponding support bases 14. Preferably, a complementary fastening structure of the seat element (e.g. rod) can be arranged or positioned in the recess(es) 13. The fastening device (e.g. bar) of the seat element can then be held by the first fastening devices (hooks) 11 of the child seat base (in particular by reaching around it). The first fastening devices 11 are arranged (at least in sections) in the area of the recesses 13 (at least in a locking position). The first fastening devices 11 are in turn (see also FIGS. 3 to 6) in operative connection with a control device 15 (control element), which in turn is connected to a connecting device (connecting element) 16.

The control device 15 according to execution can have a central section 17 (transverse or extending from left to right) and two sections 18, 19 extending (e.g., vertically) upwards from this transverse section in the direction of first connecting devices 11. Specifically, the fastening device can have at least essentially a U-shape.

Specifically, the control device 15 can be connected (e.g. centrally) to the connecting device 16 at its (transversely extending) base section 17.

The connecting device 16 in turn is preferably (at least essentially) Y-shaped (or T-shaped), and specifically has a central section 20 and two arms 21, 22 branching off from it. At the ends of the arms 21, 22, in turn, the second fastening devices (pins) 12 are located, preferably as an integral component of the connecting device 16.

Specifically, the arms can be bent at least in sections 21, 22, although this is not mandatory.

The connecting device 16 is preferably flexible at least in sections, in particular flexible both at least in sections in the central section 20 as well as at least in sections in the area of the arms 21, 22. By this, these may be displaced in a particularly easy manner (even with an integral connection of the second fastening devices 12) during an at least substantially translational movement of the connecting device 16 (in embodiments according to FIG. 1, for example, inwards, in particular to release the seat element or outwards, in particular to lock the seat element on the child seat base).

Specifically, the connecting device 16 can therefore be configured such that it changes its state by displacement on the one hand and preferably also partially by a deformation (in particular in the area of curved sections of the arms 21, 22) in the context of locking or releasing the seat element.

The (respective) second fastening device 12 and/or the seat element 100 can have a starting bevel 23, preferably in such a way that upon bringing together the seat element 100 and base 10, the (respective) fastening device 12 is temporarily pushed back when it is in the locking position (in order to then, at the end of the bringing together, move back into the locking position, e.g. to snap into it). Such a starting bevel 23 (e.g. at the top of the respective pin) can exemplary be seen in FIG. 1.

The control device 15, in turn, is preferably mounted to rotate about an axis (axis of rotation) 24 (see, for example, FIG. 3) and may not be movable purely translationally (relative to the child seat base). The control device 15 can be moved (in particular rotated) by (e.g. manual) actuation of an actuating device 27 (see FIG. 2), whereby, for example, a locking position can be cancelled so that the seat element can be removed from the child seat base. Specifically, the actuating device 27 can be mounted to rotate (about an axis) and drive the control device 15 via an arm 28, for example.

FIG. 3 shows the child seat base according to FIG. 1 in an oblique sectional view. The fastening devices 11, 12 are in their release position here.

FIG. 4 correspondingly shows the fastening devices 11, 12 in their locking position.

The mechanism for locking the seat element is explained in more detail below (see also FIGS. 5 and 6 in particular).

FIG. 5 shows a section of the child seat base in which the first fastening devices 11 are in their release position. FIG. 6 shows the corresponding section with first fastening devices in locking position. The first fastening devices 11 are aligned in sections (for example by forming a projection, possibly curved, see FIG. 5) with the recess(es) 13, so that a complementary fastening device of the child seat (e.g. rod) abuts against the corresponding section of the first fastening device 11 when it is inserted (inserted) into the recess(es) 13 and can thus cause a rotation about an axis 30 (see FIG. 5).

During such a rotation, the first fastening devices 11 are correspondingly transferred to their locking position (see FIG. 6), in which the rod (not shown there, optional) of the seat element is locked. Only when all first fastening devices 11 are in the position according to FIG. 6 can the connecting device 15 also rotate about the axis 24 (as shown in FIG. 6), which leads to the fact that also corresponding engagement devices (engagement elements or engagement arms) of the control device 15 can rotate.

In FIG. 6, the engagement devices 31 are located at a first latching area 32 of the respective first fastening device 11 and in FIG. 5 at a second latching area 33. The first latching area 32 together with the engagement device 31 enables a locking of the first fastening devices 11 in their locking position (according to FIG. 6). Specifically, the fastening devices 11 are blocked here against rotation (in both directions). In the position according to FIG. 5, the corresponding first fastening device 11 is only blocked against further rotation away from the locking position, but can (as already explained) be rotated in the direction of the locking position. However, this is generally prevented by a spring device 37. However, by overcoming the corresponding spring force, a rotation into the locking position can take place. Specifically, the spring device 37 acts in the direction of the release position, so that the corresponding first fastening device is automatically brought to its release position if it is not locked by the control device 15. Specifically, the spring device 37 can be a tension spring (alternatively, it can also be a shear spring or a spring that partially pushes and partially pulls).

According to embodiment, the control device 15 is automatically transferred from the position according to FIG. 5 to the position according to FIG. 6. This can be made possible by the connecting device 16 being acted upon by one or more spring device(s) 34 (see FIG. 3), which preferably support a movement of the connecting device 15 in such a way that the second fastening devices 12 are urged into their locking position. Particularly preferably, the spring devices 34 are arranged on the second fastening devices 12 or at least in the vicinity thereof (for example at a distance of less than 5 cm or less than 2 cm). Such a (spring) drive in the vicinity of the second fastening devices 12 can then be transmitted to the control device 15 in a simple manner via a pulling action, so that the latter can in turn be displaced (e.g. rotated). Alternatively or additionally, it would also be conceivable to provide corresponding spring devices which are arranged on another section of the connecting device 16 and/or on the control device 15, whereby, for example, a pushing transmission of action (e.g. from the control device 15 to the connecting device 16) could also take place.

Overall, the first fastening devices 11 can therefore be moved (rotated) in a simple manner by placing the seat element (whereby its weight force is preferably already sufficient), which then, via a corresponding release of the control device 15 and thus also of the connecting device 16, leads to the second fastening devices also being (automatically) transferred to their locking position. However, this is only possible if the first fastening devices (both) are transferred into their locking position, which prevents operating errors in a simple way.

In FIG. 2 also an indicating device 35 can be seen, which for example has two different surface sections (with different colours, e.g. red on the one hand and green on the other) and at least partially tracks a movement of the control device 15, so that the indicating device 35 displaces with a corresponding movement (e.g. rotation of the control device). As a result, different sections of the indicator device (e.g. either a red section or a green section) can be made visible in a window 36 of the child seat shell accordingly (see FIG. 1), so that an indication is provided for the user as to whether the locking position of the fastening device is engaged or not.

FIG. 8 shows in a highly schematic illustration four fastening elements (12), which are connected to each other via connecting devices (16). The fastening elements can be formed in one piece with the connecting elements and/or preferably as pins. The connecting devices can be (possibly injection-moulded) plastic bands, which can be guided on the shell body (not shown) and/or which can be connected to the shell body in a sliding manner (and in particular can change their shape during sliding or possibly slide “around the corner”).

The plastic bands can, for example, have at least one round and/or, preferably, at least one angular, preferably quadrangular, further preferably rectangular cross-section (in particular perpendicular to a longitudinal extension and/or direction of movement, in particular direction of sliding, at the location of the respective cross-section under consideration).

Furthermore, an actuating device (27) is shown, which can be formed in one piece with or separately from the connecting devices. It may be provided that (in the figure) the actuating device is movable in the left-right direction in order to drive the fastening devices in an up-down direction by means of the connecting devices. The connecting devices may also (or alternatively) be suitable for transmitting thrust forces, for example in such a way that an insertion of the fastening device from its locking position located further outwards into a release position located further inwards is transmitted to the actuating device by means of the connecting elements (or may not have such a suitability and/or may only be designed for tension transmission).

At this point, it should be noted that all the parts or functions described above are claimed to be essential to the invention when viewed in isolation and in any combination, in particular the details shown in the drawings. Modifications thereof are familiar to the skilled person.

Furthermore, it is pointed out that a scope of protection as broad as possible is sought. In this respect, the disclosure contained in the claims can also be specified by features that are described with further features (even without these further features necessarily being included). It is explicitly pointed out that round brackets and the term “in particular” are intended to emphasise the optionality of features in the respective context (which does not mean, conversely, that a feature is to be regarded as mandatory in the corresponding context without such identification).

### Reference Signs

10 child seat base
11 first fastening device
12 second fastening device
13 recess
14 support device (support base)
15 control device (control element)
16 connecting device (connecting element)
17 base section (central section)
18 section
19 section
20 central section
21 arm
22 arm
23 starting bevel
24 axis
27 actuating device
28 arm
30 axis
31 engagement device
32 first latching area
33 second latching area
34 spring device (spring)
37 spring device (spring)
35 indicating device
36 window
100 seat element
101 fastening device (rod)
102 fastening device (recess)

1. A child seat base for receiving a seat element of a child seat system and for mounting in a motor vehicle, comprising several fastening devices, in particular locking elements, for fastening the seat element to the child seat base, which can be brought from a locking position into a release position, wherein at least a first of the fastening devices is configured differently from at least a second of the fastening devices with respect to a rotatability or a lockability or a shape or a choice of material.

2. The child seat base according to claim 1,
wherein
at least one first of the fastening devices can be locked or is locked in its locking position by means of at least one locking device, and
at least one second of the fastening devices is not locked in its locking position.

3. The child seat base according to claim 1,
wherein
at least one fastening device comprises a hook, or
at least one fastening device comprises a pin.

4. The child seat base according to claim 1,
wherein
the at least one first fastening device is rotatable or the at least one second fastening device is translationally displaceable.

5. The child seat base according to claim 1,
wherein
the at least one first fastening device is arranged further back than the at least one second fastening device.

6. The child seat base according to claim 1,
wherein
at least one indicator device is provided, which is configured to indicate whether the at least one first fastening device is in its locking position.

7. The child seat base according to claim 1,
wherein
several first fastening devices interact with each other in such a way that they only remain in the locking position when they have all been brought into the locking position, or
several second fastening devices are coupled to each other or
several fastening devices, wherein the several fastening devices comprise at least one first and at least one second fastening device, interact with each other in such a way that a transfer of the at least one second fastening device into its locking position is enabled by a transfer of the at least one first fastening device into its locking position.

8. The child seat base according to claim 1,
wherein
several first fastening devices interact with each other via a control device, wherein the control device can be moved into at least one first and at least one second position by rotation, wherein the control device in the first position locks the locking position of the first fastening devices or can only then be transferred into the first position, when the several first fastening devices are in their locking position, or prevents the several first fastening devices from moving further away from the locking position when they are in the release position.

9. The child seat base according to claim 1,
wherein
several fastening devices are provided, wherein the several fastening devices comprise at least one first and at least one second fastening device, and wherein the fastening devices are connected to each other, at least in sections, via a connecting device, wherein the connecting device:
is configured in such a way that a transfer of the at least one second fastening device into its locking position is enabled by a transfer of the at least one first fastening device into its locking position or
is connected to the control device or
is designed to be flexible or
is designed as a band or comprises such a band or
is connected firmly, to at least one second fastening device, which forms an integral unit with at least one second fastening device.

10. The child seat base according to claim 1,
wherein
an actuating device is provided, wherein by an actuation of the actuating device at least one or several or all fastening devices are transferable into the release position.

11. The child seat base according to claim 1,
wherein
at least one first spring device is provided, which urges at least one fastening device at least one first fastening device, in the direction of the release position, or at least one second spring device is provided, which urges at least one fastening device, at least one second fastening device, in the direction of the locking position.

12. The child seat base according to claim 1,
wherein
an indicating device is provided for indicating a status of at least one fastening device, wherein the indicating device is coupled to a position of the control device.

13. The child seat base according to claim 1,
wherein
an indicating device is designed in such a way that the adoption of the locking position of the at least one first fastening device is only indicated when a transfer of the at least one second fastening device into its locking position has been enabled or has taken place, or
an actuating device is designed in such a way that the at least one first fastening device is only transferred to its release position when an indication of the locking position of the at least one first fastening device by the indicating device no longer takes place.

14. The child seat base for receiving a seat element of a child seat system and for mounting in a motor vehicle, according to claim 1,
comprising several fastening devices, in particular locking elements, for fastening the seat element on the child seat base, which can be brought from a locking position into a release position,
wherein an actuating device is provided, wherein by an actuation of the actuating device at least one or several or all fastening devices are transferable into the release position,
wherein the fastening devices are connected to each other or to the actuating device, at least in sections, via a connecting device, wherein the connecting device is flexible or in the form of a band or comprises such a band or is made of plastic as an injection-moulded part.

15. A child seat system for mounting in a motor vehicle, comprising a seat element as well as a child seat base according to claim 1.
